(19) United States
(12) Patent Application Publication
(10) Pub. No.: US 2026/0367311 A1
(43) Pub. Date: Nov. 19, 2026

(54) ANTIRESONANT HOLLOW-CORE OPTICAL FIBERS

(71) Applicant: Nufern, East Granby, CT (US)

(72) Inventors: Helena Lopez Aviles, East Granby, CT (US); Clemence Jollivet, East Granby, CT (US); Stephanie Morris, East Granby, CT (US)

(21) Appl. No.: 19/667,952

(22) Filed: May 5, 2026

Related U.S. Application Data
(60) Provisional application No. 63/807,456, filed on May 16, 2025.

(51) Int. Cl. G02B 6/02

(52) U.S. Cl. CPC G02B 6/02357; G02B 6/02328; G02B 6/02347

(57) ABSTRACT

An antiresonant hollow-core optical fiber includes an outer cladding and a structured cladding surrounding and defining a hollow core. The structured cladding includes antiresonance structures distributed about the hollow core and spaced apart from each other. Each antiresonance structure includes a first arch connected to the outer-cladding wall along two first longitudinal lines, and a second arch (a) located under but not touching the first arch and (b) connected to the outer-cladding wall along two second longitudinal lines. The two second longitudinal lines are spaced apart from the two first longitudinal lines. The absence of nodes between adjacent antiresonance structures together with the absence of nodes between the first and second arches results in consistently low loss over a wide transmission band.

### CROSS-REFERENCE TO RELATED APPLICATION

This application claims the benefit under 35 U.S.C. § 119(e) of U.S. Provisional Patent Application Ser. No. 63/807,456, filed May 16, 2025, the disclosure of which is hereby incorporated herein in its entirety by this reference.

### TECHNICAL FIELD

The present disclosure relates in general to antiresonant hollow-core optical fibers. The present disclosure relates in particular to structured-cladding designs of antiresonant hollow-core optical fibers.

### BACKGROUND

Optical fibers are used to transport light in many different application scenarios. In telecommunication and data communication systems, optical signal transmission through single-mode optical fibers offers greater speed and bandwidth than electrical signal transmission. In industrial laser-processing applications, such as laser welding and laser machining, optical fibers are used to transport multi-kilowatt laser light from a laser source to a workpiece.

A traditional optical fiber has a solid core with a higher refractive index than a surrounding cladding material. In a ray picture, total internal reflection at the interface between the core and the cladding causes light to be guided in the core. Traditional optical fibers with solid cores have certain limitations. In optical signal transmission applications, e.g., telecommunications and data communications, chromatic dispersion in the solid-core material limits the speed of information transfer. In applications requiring transport of high-power laser light, for example as needed for many types of industrial laser processing, the solid core material absorbs and/or scatters some of the laser light propagating in the optical fiber. For high-power laser light, the absorbed/scattered power may be substantial as nonlinear processes become non-negligible. Potential nonlinear processes include stimulated Brillouin scattering and stimulated Raman scattering. The absorption/scattering leads to transmission loss and, in a worst case, optical damage.

A hollow-core optical fiber, on the other hand, guides light in a hollow core such that the light propagates in air, in an optically-inert gas, or in a vacuum. As a result, hollow-core fibers exhibit essentially zero chromatic dispersion and have significantly reduced absorption/scattering losses and reduced optical nonlinearities compared to traditional solid-core fibers. Hollow-core fibers are therefore an attractive alternative to traditional solid-core fibers in industrial laser-processing applications as well as in telecommunications and data communications.

The notion of a hollow-core fiber was conceived more than fifty years ago as a low-loss alternative to traditional solid-core optical fibers. The first practical implementations were, however, not realized until the 1990s. These first hollow-core fibers relied on the photonic bandgap effect to guide light in a hollow core surrounded by a microstructured photonic-bandgap cladding having many smaller hollow channels arranged in a honeycomb-like pattern.

More recently, simpler designs have been developed with light-guiding based on antiresonance, that is, destructive optical interference of the component of the laser light that would otherwise propagate radially away from the optical axis defined by the center of the core. These antiresonant hollow-core fibers tend to be easier to manufacture than photonic-bandgap hollow-core fibers. Examples of antiresonant hollow-core fiber designs include Kagome fibers, revolver fibers, and nested antiresonant nodeless fibers (NANFs). In each of these designs, a hollow core is surrounded by a structured cladding that has several hollow channels. The radial component of light undergoes partial reflections at the walls of the structured cladding, and these walls are configured such that the partial reflections interfere in a manner similar to a Fabry-Perot interferometer. There is constructive interference around the center of the core and destructive interference around the structured cladding. As a result, the structured cladding guides light, at the design wavelength, to propagate longitudinally through the hollow core.

NANF, especially, has garnered interest by virtue of exhibiting very low transmission loss. The structured cladding of a conventional NANF includes a plurality of larger tubes distributed about the hollow core, with a smaller tube nested within each larger tube. The result is a series of nested-tube pairs surrounding the hollow core. The term “nodeless” in the name “nested antiresonant nodeless fiber” refers to the adjacent tube pairs being spaced apart from each other, such that there are no “nodes” (contact points) between adjacent tube pairs. In each pair, the larger tube and the smaller tube are connected to the cladding wall at the same location. Some NANFs, referred to as double-NANFs (DNANFs), have an additional even-smaller tube nested inside each smaller tube, such that the hollow core is surrounded by a series of tube-triplets. Certain DNANFs exhibit particularly low transmission loss.

### BRIEF SUMMARY

Disclosed herein are antiresonant hollow-core optical fibers configured with a structured cladding that includes a plurality of antiresonance structures distributed about the hollow core and supported by an outer-cladding wall. There is no contact, i.e., no nodes, between adjacent antiresonance structures, resulting in low transmission loss. Additional advantages stem from the internal configuration of the antiresonance structures. Each antiresonance structure includes two arches, situated in a nested manner such that one is located “beneath” the other, between the other arch and the outer-cladding wall. Both arches are supported by the wall of an outer cladding. Each of the two arches is connected to the cladding wall along two lines (straight or curved) that are oriented along the longitudinal dimension of the fiber. The arch geometry allows for the two arches of each antiresonance structure to be connected to the cladding wall without touching each other. This eliminates nodes that are present in conventional NANFs, namely the contact between the two tubes of each nested-tube pair where they connect to the cladding wall. These nodes produce Fano resonances that result in spectral oscillations, that is, oscillating transmission as a function of wavelength. The use of arches in the present fiber eliminates, or at least reduces, such spectral oscillations. The present fibers may therefore exhibit consistently low loss over an extended wavelength range. In some embodiments, the low-loss wavelength range includes one or more commonly used optical-communication transmission bands.

In one aspect of the present disclosure, an antiresonant hollow-core optical fiber includes a tube and a structured cladding. The tube forms an outer cladding with an inward-facing surface forming an outer-cladding wall. The structured cladding is disposed on the outer-cladding wall and surrounds and defines a hollow core. The structured cladding includes a plurality of antiresonance structures distributed about the hollow core. Each of the antiresonance structures is spaced apart from each other one of the antiresonance structures and includes first and second arches. The first arch is connected to the outer-cladding wall along two first longitudinal lines mutually bounding the first arch. The second arch (a) is located between the outer-cladding wall and the first arch, (b) does not touch the first arch, and (c) is connected to the outer-cladding wall along two second longitudinal lines mutually bounding the second arch. The two second longitudinal lines are spaced apart from the two first longitudinal lines.

In another aspect of the present disclosure, a preform for an antiresonant hollow-core optical fiber includes an outer tube and a structured layer. The outer tube has an inward-facing surface. The structured layer is disposed on the inward-facing surface of the outer tube and surrounds and defines a hollow channel. The structured layer includes a plurality of multi-element structures distributed about the hollow channel. Each of the multi-element structures is spaced apart from each other one of the multi-element structures and includes first and second arches. The first arch is connected to the inward-facing surface along two first longitudinal lines mutually bounding the first arch. The second arch (a) is located between the outer tube and the first arch, (b) does not touch the first arch, and (c) is connected to the inward-facing surface along two second longitudinal lines mutually bounding the second arch. The two second longitudinal lines are spaced apart from the two first longitudinal lines.

### BRIEF DESCRIPTION OF THE DRAWINGS

The accompanying drawings, which are incorporated in and constitute a part of the specification, schematically illustrate preferred embodiments of the present disclosure, and together with the general description given above and the detailed description of the preferred embodiments given below, serve to explain principles of the present disclosure.

FIG. 1 illustrates an antiresonant hollow-core optical fiber with a structured cladding containing arches, according to an embodiment.

FIG. 2 is a more detailed view of an antiresonance structure of the structured cladding of the FIG. 1 fiber.

FIG. 3 illustrates an antiresonance structure that includes or is composed of three arches and that may be implemented in the structured cladding of an embodiment of the FIG. 1 fiber.

FIG. 4 illustrates an antiresonance structure that includes or is composed of two arches and a tube and that may be implemented in the structured cladding of an embodiment of the FIG. 1 fiber.

FIG. 5 illustrates an antiresonance structure that includes or is composed of four arches and that may be implemented in the structured cladding of an embodiment of the FIG. 1 fiber.

FIG. 6 illustrates an antiresonance structure that includes or is composed of three arches with truncated-elliptical or truncated-oval transverse cross sections. This antiresonance structure may be implemented in the structured cladding of an embodiment of the FIG. 1 fiber.

FIG. 7 illustrates an antiresonance structure that includes or is composed of arches of different shapes and that may be implemented in the structured cladding of an embodiment of the FIG. 1 fiber.

FIG. 8 is a more detailed view of the structured cladding of the FIG. 1 fiber, in an embodiment that includes three arches in each antiresonance structure, and wherein the antiresonance structures are identical to each other and evenly distributed about the longitudinal axis of the fiber.

FIG. 9 is a detailed view of the structured cladding of an embodiment of the FIG. 1 fiber that implements the FIG. 7 antiresonance structures, and wherein the antiresonance structures are identical to each other and evenly distributed about the longitudinal axis of the fiber.

FIG. 10 plots calculated transmission-loss as a function of wavelength for two embodiments of the FIG. 1 fiber.

FIG. 11 illustrates a nested antiresonance hollow-core optical fiber with nodes in its structured cladding. A calculated transmission-loss for this fiber is included in the FIG. 10 plot for comparison.

### DETAILED DESCRIPTION

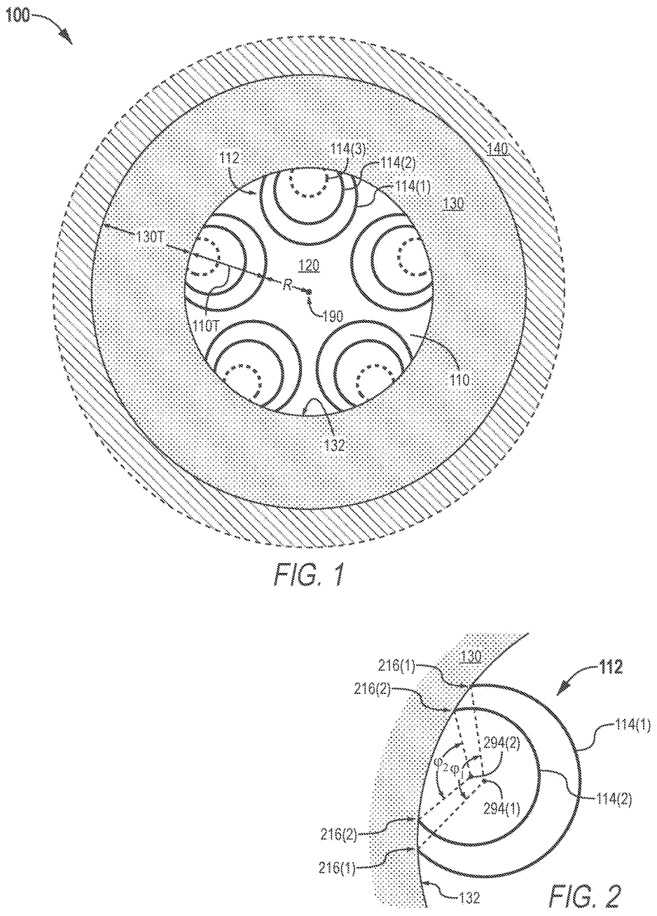

Referring now to the drawings, wherein like components are designated by like numerals, FIG. 1 illustrates one antiresonant hollow-core optical fiber 100 with a structured cladding containing arches. FIG. 1 shows fiber 100 in a transverse cross-sectional view orthogonal to the longitudinal axis 190 of fiber 100. Fiber 100 includes a structured cladding 110 and an outer cladding 130. Structured cladding 110 surrounds and defines a hollow core 120. Outer cladding 130 has an inward-facing surface that forms a cladding wall 132. Structured cladding 110 is supported by cladding wall 132. Fiber 100 may also include a jacket 140 disposed on an outward-facing surface of outer cladding 130. Although not shown in FIG. 1, fiber 100 may include additional layers outside outer cladding 130.

Fiber 100 is not necessarily drawn to scale in FIG. 1. In one example, hollow-core 120 has a radius R (defined as the distance from longitudinal axis 190 to physical elements of structured cladding 110) in the range between 5 and 40 micrometers (μm), the thickness 110T of structured cladding 110 is in the range between 8 and 45 μm, and the thickness 130T of outer cladding 130 is at least 100 μm. Structured cladding 110 and outer cladding 130 may be made of the same type or different types of glass. Jacket 140 may include a polymer.

Structured cladding 110 includes a plurality of antiresonance structures 112 disposed on cladding wall 132. Antiresonance structures 112 are distributed about hollow core 120 and spaced apart from each other such that there is no contact (i.e., no nodes) between adjacent antiresonance structures 112. The depicted embodiment of structured cladding 110 is configured with five antiresonance structures 112. Without departing from the scope hereof, structured cladding 110 may include more or fewer antiresonance structures 112 than depicted. For example, desirable transmission properties have been achieved for embodiments with eight or fewer antiresonance structures 112, e.g., between four and eight antiresonance structures 112.

FIG. 2 illustrates antiresonance structure 112 in further detail. FIG. 2 is a closeup of a portion of the FIG. 1 cross section showing a single antiresonance structure 112. Antiresonance structure 112 includes at least two arches 114(1) and 114(2) extending along longitudinal axis 190 (indicated in FIG. 1).

Herein, an “arch” may refer to an object comprising a linear extrusion (e.g., in the longitudinal direction of the fiber) of an arc shape. Herein, an “arc” may refer to a segment of a circle, ellipse, parabola, or other curve, wherein the segment has two opposite ends that are spaced apart from each other. Arches described herein define an open area beneath them. Arches described herein have an arc shape in cross-section. Arches described herein may have a thin, uniform thickness in the transverse dimensions orthogonal to the longitudinal dimension of the fiber.

Arch 114(1) is connected to cladding wall 132 along two lines 216(1) extending parallel to longitudinal axis 190 of fiber 100. Arch 114(1) is bounded by lines 216(1). Arch 114(2) is positioned under arch 114(1) in the space enclosed by arch 114(1) and the portion of cladding wall 132 between longitudinal lines 216(1). Arch 114(2) is connected to cladding wall 132 along two longitudinal lines 216(2) bounding arch 114(2). Longitudinal lines 216(2) are spaced apart from longitudinal lines 216(1), and arches 114(1) and 114(2) do not touch each other.

In the depicted example, the transverse cross section of each of arches 114(1) and 114(2) is an arc of a circle. As compared to a full circle, the arc corresponding to arch 114(1) is missing an azimuthal segment φ₁. Similarly, the arc corresponding to arch 114(2) is missing an azimuthal segment φ₂.

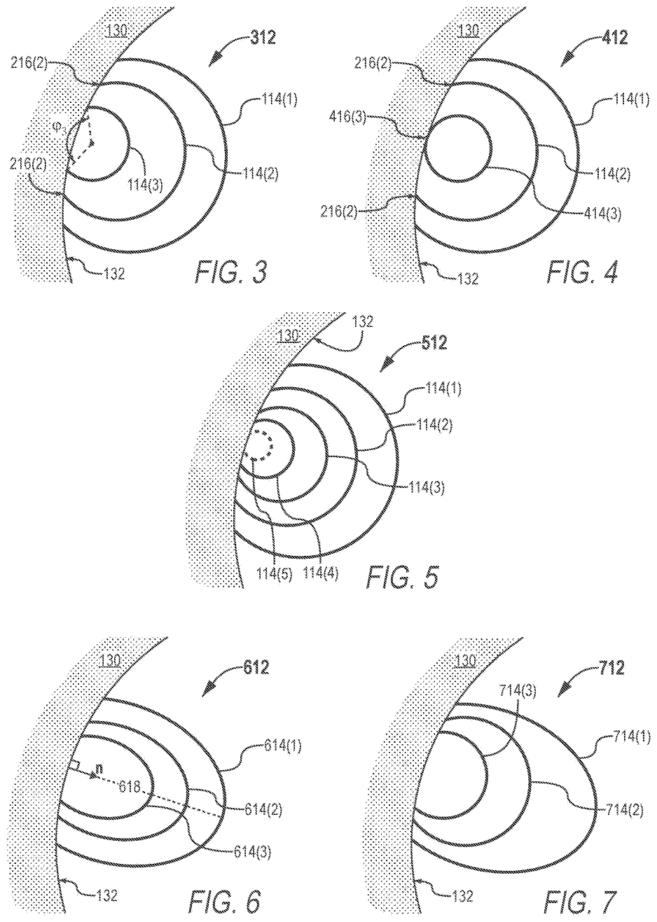

Referring again to FIG. 1, antiresonance structure 112 may include additional arches 114. An optional third arch 114(3) is depicted in FIG. 1. In one embodiment, antiresonance structure 112 includes up to five arches 114 successively decreasing in size and arranged inside each other according to size. Arches 114 may have circular, elliptical, or oval transverse cross sections apart from the missing segment, as shown in FIGS. 1 and 2. That is, the transverse cross section of each arch 114 may be truncated-circular, truncated-elliptical, or truncated-oval. Other round shapes are possible as well, for example rounded shapes characterized by inward-pointing radii of curvature along the full perimeter of the transverse cross section of the arch. All arches 114 of antiresonance structure 112 may have the same general shape, for example all characterized by a truncated-circular transverse cross section. Alternatively, antiresonance structure 112 may include arches 114 of different shapes. In certain embodiments, all antiresonance structures 112 of structured cladding 110, or at least arches 114(1) and 114(2) thereof, are identical and evenly distributed about longitudinal axis 190. FIGS. 3-7 illustrate exemplary embodiments of antiresonance structure 112.

FIG. 3 illustrates one antiresonance structure 312 that includes or is composed of three arches 114(1), 114(2), and 114(3). Arch 114(3) is positioned under arch 114(2) in the space enclosed by arch 114(2) and an associated portion of cladding wall 132 between longitudinal lines 216(2). Arch 114(3) is connected to cladding wall 132 along two longitudinal lines that are spaced apart from longitudinal lines 216(2). In one embodiment of antiresonance structure 312, the transverse cross sections of arches 114(1), 114(2), and 114(3) are truncated-circular in shape, and missing azimuthal segments φ₁ and φ₂ (see FIG. 2) are at least 50 degrees and 60 degrees, respectively. The missing azimuthal segment φ₃ characterizing the transverse cross section of arch 114(3) may be smaller than missing azimuthal segments φ₁ and φ₂.

FIG. 4 illustrates one antiresonance structure 412 that includes or is composed of two arches 114(1) and 114(2) and a tube 414(3). Tube 414(3) is situated in the space under arch 114(2) and enclosed by arch 114(2) and an associated portion of cladding wall 132 between longitudinal lines 216(2). Tube 414(3) is connected to cladding wall 132 along a single longitudinal line 416(3). In one example of antiresonance structure 412, the transverse cross sections of arches 114(1) and 114(2) are truncated-circular.

FIG. 5 illustrates one antiresonance structure 512 that includes or is composed of four arches 114(1), 114(2), 114(3), and 114(4). Antiresonance structure 512 is an extension of antiresonance structure 312 wherein a fourth arch 114(4) is positioned under arch 114(3) in the space enclosed by arch 114(3) and an associated portion of cladding wall 132. Fourth arch 114(4) is missing an azimuthal segment and is connected to cladding wall 132 along two longitudinal lines that are spaced apart from the longitudinal lines where arch 114(3) connects to cladding wall 132. Arches 114(1), 114(2), 114(3), and 114(4) of antiresonance structure 512 may have truncated-circular cross sections.

Optionally, antiresonance structure 512 further includes a fifth arch 114(5) that is (a) positioned under arch 114(4) in the space enclosed by arch 114(4) and an associated portion of cladding wall 132, and (b) connected to cladding wall 132 along two longitudinal lines that are spaced apart from the longitudinal lines where arch 114(4) connects to cladding wall 132. The transverse cross section of arch 114(5) may be truncated-circular. In a modification, arch 114(5) is replaced by a tube similar to tube 414(3) of antiresonance structure 412.

In a modification of antiresonance structure 512, arch 114(4) is replaced by a tube similar to tube 414(3) of antiresonance structure 412. In order to avoid nodes between different elements of antiresonance structure 512, this modification of antiresonance structure 512 preferably does not include arch 114(5).

FIG. 6 illustrates one antiresonance structure 612 that includes or is composed of three arches 614(1), 614(2), and 614(3) with truncated-elliptical or truncated-oval transverse cross sections. Antiresonance structure 612 is an embodiment of antiresonance structure 312, wherein arches 114(1), 114(2), and 114(3) have truncated-elliptical or truncated-oval transverse cross sections. In the case of truncated-elliptical cross sections, the major axis of each ellipse may be orthogonal to cladding wall 132 at the location where the major axis intersects cladding wall 132. In the case of truncated-oval transverse cross sections, a long axis of each oval may be orthogonal to cladding wall 132 at the location where the long-axis intersects cladding wall 132. For example, as shown in FIG. 6, a major axis or long axis 618 of arch 614(1) may be parallel to a coinciding normal vector of cladding wall 132.

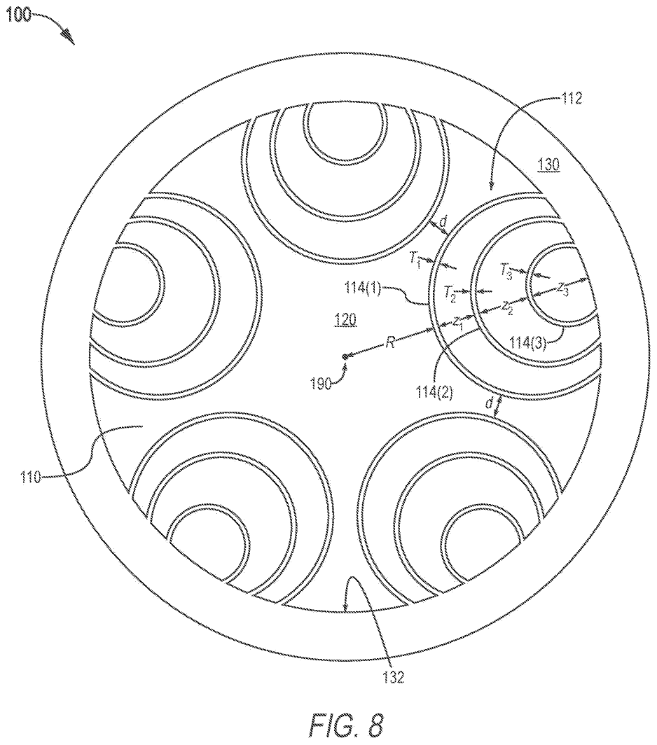

FIG. 7 illustrates one antiresonance structure 712 that includes or is composed of arches of different shapes. Antiresonance structure 712 includes (or is composed of) arches 714(1), 714(2), and 714(3). Arch 714(1) has a truncated-elliptical or truncated-oval transverse cross section, while the transverse cross sections of arches 714(2) and 714(3) are truncated-circular.

FIG. 8 is a more detailed view of structured cladding 110, in an embodiment that includes third arch 114(3) in each antiresonance structure 112, and wherein antiresonance structures 112 are identical to each other and evenly distributed about longitudinal axis 190. In one implementation, the transverse cross section of each arch 114 of antiresonance structure 112 is truncated-circular.

Arches 114(1), 114(2), and 114(3) have respective thicknesses T₁, T₂, and T₃ that may be in the range between 0.2 and 2 μm. Thicknesses T₁, T₂, and T₃ may be substantially identical such that each arch provides optimal antiresonance for the design wavelength of fiber 100. The minimum distance d between adjacent antiresonance structures 112 is greater than zero to prevent nodes between adjacent arches 114(1). In one embodiment, d/T₁>0.1.

The transmission loss in fiber 100 is sensitive to the distances between the different elements of the individual antiresonance structures, even when nodes therebetween are avoided. The transmission loss is particularly sensitive to the radial distance z₁ between the two largest arches, arches 114(1) and 114(2). Preferably, to minimize or reduce transmission loss, z₁/R>0.1, wherein z₁ is the radial distance between arches 114(1) and 114(2). In embodiments of fiber 100 that include third arch 114(3), it is also beneficial from a loss-minimization perspective, if the radial distance z₂ between arches 114(2) and 114(3) and the radial distance z₃ between arch 114(3) and cladding wall 132 obey the relationships z₂/R>0.1 and z₃/R>0.2.

Desirable transmission properties of fiber 100 may further result from the distance between arches 114(1) and 114(2) varying with an azimuthal angle with respect to a center axis of the second arch. For example, when arches 114(1) and 114(2) have truncated-circular transverse cross sections, this corresponds to the underlying circles being non-concentric. This scenario is depicted in FIG. 2, where the center axis 294(1) of arch 114(1) is radially offset from the center axis 294(2) of arch 114(2).

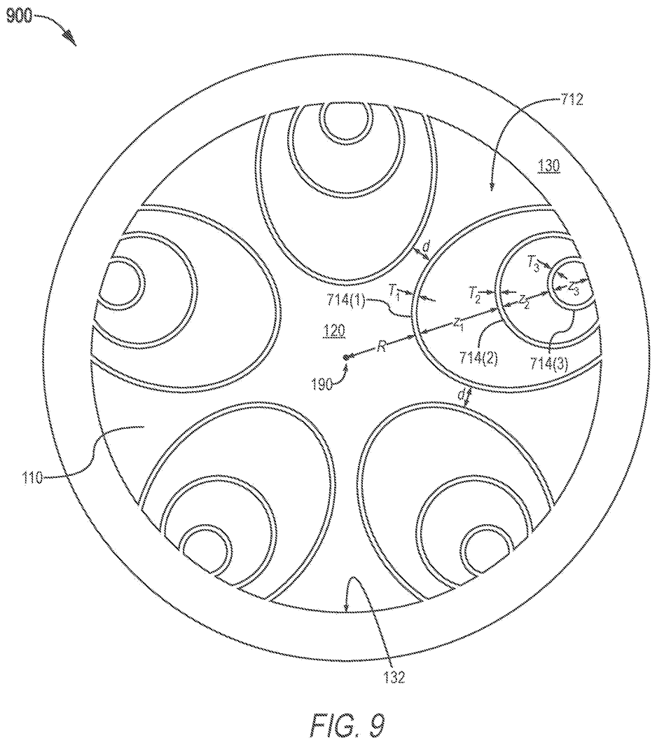

FIG. 9 is a detailed view of structured cladding 110 of one antiresonant hollow-core optical fiber 900 that implements antiresonance structures 712 (see FIG. 7), and wherein antiresonance structures 712 are identical to each other and evenly distributed about longitudinal axis 190. Fiber 900 is an embodiment of fiber 100. The discussion, in reference to FIG. 8, of properties of wall thicknesses, distances between adjacent antiresonance structures, and radial distances between arches of individual antiresonance structures applies to fiber 900 as well.

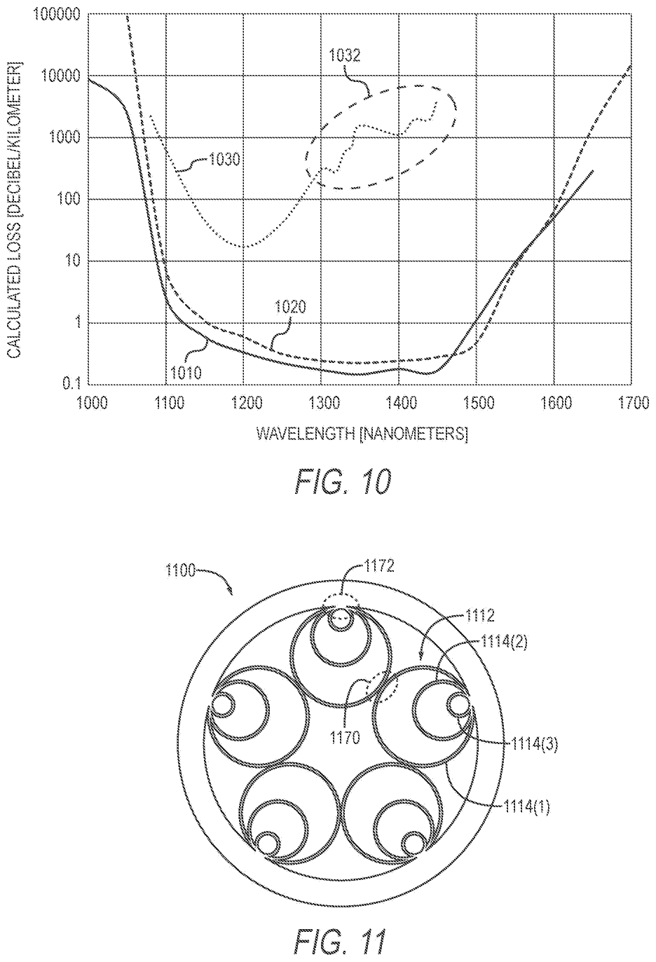

FIG. 10 plots calculated transmission-loss as a function of wavelength for two embodiments of fiber 100. Loss curve 1010 pertains to an example of the embodiment of fiber 100 depicted in FIG. 8. More specifically, loss curve 1010 pertains to an example of fiber 100 wherein (a) structured cladding 110 includes five antiresonance structures 112, (b) antiresonance structures 112 are identical to each other and evenly distributed about longitudinal axis 190, (c) antiresonance structure 112 is composed of arches 114(1), 114(2), and 114(3) with truncated-circular transverse cross sections, (d) thicknesses T₁, T₂, and T₃ are identical, and (e) d/T₁>0.1, z₁/R>0.1, z₂/R>0.1, and z₃/R>0.2. Furthermore, the parameters of structured cladding 110 are optimized for low loss in the wavelength range between 1200 and 1450 nanometers (nm), approximately. Loss curve 1020 pertains to an example of fiber 900 (see FIG. 9) that is configured with five identical and evenly distributed antiresonance structures 712, and wherein (a) thicknesses T₁, T₂, and T₃ are identical, and (b) d/T₁>0.1, z₁/R>0.1, z₂/R>0.1, and z₃/R>0.2.

For comparison, FIG. 10 also plots a loss curve 1030 for a nested antiresonance hollow-core optical fiber with nodes in its structured cladding.

FIG. 11 illustrates the nested antiresonance hollow-core optical fiber 1100 associated with loss curve 1030. The structured cladding of fiber 1100 includes five identical and evenly distributed antiresonance structures 1112, each including three nested tubes 1114(1), 1114(2), and 1114(3). Antiresonance structures 1112 are sized such that nodes 1170 exist between adjacent tubes 1114(1). Additionally, nodes 1172 between all three nested tubes of each antiresonance structure 1112 exist at the cladding wall. Fiber 1100 is similar to the fiber pertaining to loss curve 1010 apart from (a) the structured cladding being composed of tubes, (b) adjacent antiresonance structures 1112 contacting each other, and (c) tubes of each individual antiresonance structure 1112 touching each other.

When comparing loss curves 1010, 1020, and 1030 in FIG. 10, it is evident that nodes 1170 of fiber 1100 introduce substantial transmission loss and narrower transmission spectral bandwidth than for the fibers associated with loss curves 1010 and 1020. In addition, both nodes 1170 and nodes 1172 of fiber 1100 introduce Fano resonances that lead to spectral oscillations in region 1032. In contrast, loss curves 1010 and 1020 both exhibit wide low-loss transmission bands with no noticeable spectral oscillations, spanning from approximately 1150 nm to approximately 1500 nm. Particularly low loss is achieved through the region from 1250 nm to 1450 nm. Throughout this region, loss curve 1010 is below 0.2 decibel/kilometer (dB/km), and loss curve 1020 is below 0.3 dB/km.

Referring again to FIG. 1, the manufacture of fiber 100 may entail a fiber drawing process. The fiber drawing process starts with a preform that includes an outer tube with an inward-facing surface and a structured layer disposed on the inward-facing surface of the outer tube. Via the drawing process, the outer tube becomes outer cladding 130, while the structured layer becomes structured cladding 110. A transverse cross section of the preform contains the same features as the transverse cross section of outer cladding 130 and structured cladding 110 of fiber 100. Thus, omitting jacket 140, the transverse cross section depicted in FIG. 1 may be viewed as a transverse cross section of a preform that can be drawn to produce fiber 100. The preform has different overall dimensions than fiber 100, with a much larger transverse extent and much shorter longitudinal extent.

The present disclosure is described above in terms of a preferred embodiment and other embodiments. The invention is not limited, however, to the embodiments described and depicted herein. Rather, the invention is limited only by the claims appended hereto.

What is claimed is:

1. An antiresonant hollow-core optical fiber, comprising:
a tube forming an outer cladding with an inward-facing surface forming an outer-cladding wall; and
a structured cladding disposed on the outer-cladding wall and surrounding and defining a hollow core, the structured cladding including a plurality of antiresonance structures distributed about the hollow core, each of the antiresonance structures being spaced apart from each other one of the antiresonance structures and including:
a first arch connected to the outer-cladding wall along two first longitudinal lines mutually bounding the first arch, and
a second arch (a) located between the outer-cladding wall and the first arch, (b) not touching the first arch, and (c) connected to the outer-cladding wall along two second longitudinal lines mutually bounding the second arch, the two second longitudinal lines being spaced apart from the two first longitudinal lines.

2. The antiresonant hollow-core optical fiber of claim 1, wherein a distance from the first arch along a radius of the outer-cladding wall, centered on the first arch, to the second arch is at least 10 percent of a radius of the hollow core.

3. The antiresonant hollow-core optical fiber of claim 1, wherein a minimum distance between the first arch of each of the antiresonance structures and the first arch of each adjacent one of the antiresonance structures is at least 10 percent of a wall-thickness of the first arches.

4. The antiresonant hollow-core optical fiber of claim 1, wherein:
the first and second arches of each of the antiresonance structures are identical to the first and second arches, respectively, of each other one of the antiresonance structures; and
the antiresonance structures are evenly distributed about the hollow core.

5. The antiresonant hollow-core optical fiber of claim 1, wherein a distance between the first and second arches varies with an azimuthal angle with respect to a center axis of the second arch.

6. The antiresonant hollow-core optical fiber of claim 1, wherein each of the antiresonance structures further includes a tube (a) located between the outer-cladding wall and the second arch, (b) not touching the second arch, and (c) connected to the outer-cladding wall.

7. The antiresonant hollow-core optical fiber of claim 1, wherein each of the antiresonance structures further includes a third arch (a) located between the outer-cladding wall and the second arch, (b) not touching the second arch, and (c) connected to the outer-cladding wall along two third longitudinal lines that are spaced apart from the two second longitudinal lines.

8. The antiresonant hollow-core optical fiber of claim 7, wherein each of the antiresonance structures further includes a fourth arch (a) located between the outer-cladding wall and the third arch, (b) not touching the third arch, and (c) connected to the outer-cladding wall along two fourth longitudinal lines that are spaced apart from the two third longitudinal lines.

9. The antiresonant hollow-core optical fiber of claim 8, wherein:
each of the antiresonance structures further includes a fifth arch (a) located between the outer-cladding wall and the fourth arch, (b) not touching the fourth arch, and (c) connected to the outer-cladding wall along two fifth longitudinal lines that are spaced apart from the two fourth longitudinal lines.

10. The antiresonant hollow-core optical fiber of claim 7, wherein, along a radius of the outer-cladding wall centered on the first arch:
a distance between the first and second arches is at least 10 percent of a radius of the hollow core;
a distance between the second and third arches is at least 10 percent of the radius of the hollow core; and
a distance from the outer-cladding wall to the third arch is at least 20 percent of the radius of the hollow core.

11. The antiresonant hollow-core optical fiber of claim 1, wherein the structured cladding contains eight or fewer of the antiresonance structures.

12. The antiresonant hollow-core optical fiber of claim 1, wherein the first arch has a first truncated-circular transverse cross section.

13. The antiresonant hollow-core optical fiber of claim 12, wherein the second arch has a second truncated-circular transverse cross section that is non-concentric with the first truncated-circular transverse cross section.

14. The antiresonant hollow-core optical fiber of claim 1, wherein the first arch has a first truncated-elliptical or truncated-oval transverse cross section.

15. The antiresonant hollow-core optical fiber of claim 14, wherein a long axis of the first truncated-elliptical or truncated-oval transverse cross section is orthogonal to the outer-cladding wall at an intersection therebetween.

16. The antiresonant hollow-core optical fiber of claim 1, wherein each of the first and second arches has a truncated-oval transverse cross section.

17. The antiresonant hollow-core optical fiber of claim 1, wherein the first and second arches have the same wall thickness.

18. The antiresonant hollow-core optical fiber of claim 1, wherein the first arch has a truncated-elliptical transverse cross section, and the second arch has a truncated-circular transverse cross section.

19. A preform for an antiresonant hollow-core optical fiber, comprising:
an outer tube with an inward-facing surface; and
a structured layer disposed on the inward-facing surface of the outer tube and surrounding and defining a hollow channel, the structured layer including a plurality of multi-element structures distributed about the hollow channel, each of the multi-element structures being spaced apart from each other one of the multi-element structures and including:
a first arch connected to the inward-facing surface along two first longitudinal lines mutually bounding the first arch, and
a second arch (a) located between the outer tube and the first arch, (b) not touching the first arch, and (c) connected to the inward-facing surface along two second longitudinal lines mutually bounding the second arch, the two second longitudinal lines being spaced apart from the two first longitudinal lines.
